(19) United States
(12) Patent Application Publication
(10) Pub. No.: US 2008/0130437 A1
(43) Pub. Date: Jun. 5, 2008

(54) Optical disk apparatus and land-pre-pit reproducing method

(75) Inventors: Junichi Kanenaga, Tokyo (JP); Kensuke Fujimoto, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/801,387

(22) Filed: May 9, 2007

(30) Foreign Application Priority Data
May 11, 2006 (JP) JP2006-132800

(51) Int. Cl. G11B 15/52

(52) U.S. Cl. 369/47.27

(57) ABSTRACT

In an optical disk apparatus using an optical disk having groove tracks and land tracks alternately arranged therein and land pre-pits indicating position information defined in the land tracks, the optical disk is irradiated with a light beam and light reflected from the optical disk is received on divisional light-receiving surfaces to generate a light detection signal for each of the light-receiving surfaces. A pre-pit component signal corresponding to the land pre-pits is generated based on the light detection signals. A binarization-level signal is output. A pre-pit detection signal is generated by comparing the pre-pit component signal with the binarization-level signal. The position information is obtained using the pre-pit detection signal. Pulses of the pre-pit detection signal are counted in units of a period that is based on the position information. The signal level of the binarization-level signal is controlled based on the count values.

### CROSS REFERENCES TO RELATED APPLICATIONS

The present invention contains subject matter related to Japanese Patent Application JP 2006-132800 filed in the Japanese Patent Office on May 11, 2006, the entire contents of which are incorporated herein by reference.

### BACKGROUND OF THE INVENTION

1. Field of the Invention

The present invention relates to optical disk apparatuses and land-pre-pit reproducing methods. More specifically, the present invention relates to an optical disk apparatus and a land-pre-pit reproducing method in which a pre-pit component signal corresponding to land pre-pits is generated on the basis of a light detection signal generated in response to reception of light reflected from an optical disk, and pulses of a pre-pit detection signal obtained by binarizing the pre-pit component signal are counted in units of a predetermined period to control a level for binarizing the pre-pit component signal (hereinafter referred to as a “binarization level”) so that the counting result has a preset value.

2. Description of the Related Art

In the field of optical disks, recently, large-capacity recordable optical disks with playback compatibility have become widespread rapidly. DVD Recordable (DVD-R) and DVD Re-recordable (DVD-RW) disks using a land pre-pit addressing method have also extended their market share.

DVD-R disks are write-once DVD disks, and DVD-RW disks are rewritable DVD disks. In either disk, as shown in FIG. 12, groove tracks 11 and land tracks 12 are alternately arranged on a surface of a disk substrate. The groove tracks 11 and the land tracks 12 are formed in a coaxial spiral shape. The groove tracks 11 are finely waved, or wobbled, in the radial direction. The land tracks 12 have grooves formed therein in advance, which are called land pre-pits 13. The land pre-pits 13 indicate position information on the optical disk. For example, when information data is recorded, the land pre-pits 13 are read using a light beam BM to determine the recording position or control the recording timing.

In an optical disk apparatus using an optical disk having such land pre-pits, the optical disk is irradiated with a light beam, and a push-pull signal including wobble and land pre-pit components is generated on the basis of light reflected from the optical disk. The generated push-pull signal is compared with a threshold value to perform binarization, and a land pre-pit detection signal indicating land pre-pits is generated. In the optical disk apparatus, further, address detection and disk rotation control are performed from the generated land pre-pit detection signal and a signal based on the wobble component included in the push-pull signal. Therefore, the land pre-pit detection performance largely affects the signal reading and writing performance.

Since the signal level of the portion corresponding to the land pre-pits in the push-pull signal is influenced by a reduction in reflectivity involved with recording, signal levels differ between an unrecorded disk and a recorded disk. The signal level also changes during playback and recording. Japanese Unexamined Patent Application Publication No. 2002-312941 discloses that a threshold value is set between the maximum value of data corresponding to an information recording track and the minimum value of data corresponding to pre-pits to optimally set the threshold value. Japanese Unexamined Patent Application Publication No. 2003-51120 discloses that a threshold value is set between a low-frequency component extracted from a push-pull signal and the bottom level of the push-pull signal to optimally set the threshold value.

### SUMMARY OF THE INVENTION

However, there are problems when the signal level of an analog signal such as a push-pull signal is measured and a threshold value is adjusted on the basis of the measured signal level. That is, if the threshold value is set when the signal-to-noise (S/N) ratio of the push-pull signal is low, the threshold value is influenced by noise, and it is difficult to optimally set the threshold value. Further, it is difficult to optimally set the threshold value, thus preventing correct detection of land pre-pits and causing degradation of the signal reading or writing performance.

It is therefore desirable to provide an optical disk apparatus and a land-pre-pit reproducing method in which the detection accuracy of land pre-pits is improved.

According to an embodiment of the present invention, an optical disk apparatus using an optical disk having groove tracks and land tracks alternately arranged therein and land pre-pits indicating position information defined in the land tracks includes the following elements. An optical head unit having divisional light-receiving surfaces irradiates the optical disk with a light beam, and receives light reflected from the optical disk on the divisional light-receiving surfaces to generate a light detection signal for each of the divisional light-receiving surfaces. A signal generation unit generates a pre-pit component signal corresponding to the land pre-pits on the basis of the light detection signals. A binarization-level-signal output unit outputs a binarization-level signal. A binarization unit compares the pre-pit component signal with the binarization-level signal to generate a pre-pit detection signal indicating the comparison result. A decoding unit obtains the position information using the pre-pit detection signal. A pulse counting unit counts pulses of the pre-pit detection signal in units of a period that is based on the position information. A control unit controls a signal level of the binarization-level signal on the basis of the count values obtained by the pulse counting unit.

According to another embodiment of the present invention, a land-pre-pit reproducing method includes the steps of irradiating an optical disk with a light beam and receiving light reflected from the optical disk on divisional light-receiving surfaces to generate a light detection signal for each of the divisional light-receiving surfaces, the optical disk having groove tracks and land tracks alternately arranged therein and land pre-pits defined in the land tracks; generating a pre-pit component signal corresponding to the land pre-pits on the basis of the light detection signals; outputting a binarization-level signal; performing binarization by comparing the pre-pit component signal with the binarization-level signal to generate a pre-pit detection signal; counting pulses of the pre-pit detection signal in units of a predetermined period; and controlling a signal level of the binarization-level signal on the basis of the obtained pulse count values.

For example, the signal generation unit generates a push-pull signal on the basis of the light detection signals. The generated push-pull signal is filtered to extract a signal component corresponding to the land pre-pits to generate a pre-pit component signal. The pulse counting unit counts pulses of a pre-pit detection signal obtained by comparing the pre-pit component signal with the binarization-level signal and performing binarization. Pulse counting is performed in units of a predetermined period that is based on position information obtained by decoding the pre-pit detection signal, for example, in units of physical sectors. The control unit controls the signal level of the binarization-level signal on the basis of the count values. For example, the control unit controls the signal level of the binarization-level signal so that the average of the count values or the sum of the count values becomes equal to a preset value. The preset value is not limited to one value, and may include values within a certain range.

The optical disk apparatus may further includes a pulse width measurement unit configured to measure pulse widths of the pulses of the pre-pit detection signal to create a distribution of the pulse widths, and the signal level of the binarization-level signal may be controlled on the basis of the distribution of the pulse widths so that the distribution of the pulse widths converges to a pulse width corresponding to the land pre-pits. For example, a frequency distribution of the pulse widths may be created, and the signal level of the binarization-level signal may be controlled on the basis of the result of comparing frequencies of occurrence for individual classes in the frequency distribution.

According to the embodiments of the present invention, the binarization level is controlled so that an average of count values obtained by counting pulses of a pre-pit detection signal becomes equal to a preset value. The influence of noise or the like is smaller than that in the case where, for example, the signal level of a push-pull signal is measured and the binarization level is controlled on the basis of the measured signal level. Therefore, the binarization level can be optimally adjusted at any position during recording or playback. Further, since the binarization level can be optimally adjusted, the performance such as address detection can be improved, and the recording quality and the like can also be improved.

### BRIEF DESCRIPTION OF THE DRAWINGS

FIG. 1 is a diagram showing the structure of an optical disk apparatus;

FIG. 2 is a diagram showing a portion of the structure of a light detector;

FIGS. 3A to 3C are diagrams showing signals generated by a signal generation unit;

FIG. 4 is a diagram showing a track structure;

FIG. 5 is a diagram showing a land-pre-pit data frame structure;

FIG. 6 is a diagram showing bit allocation;

FIG. 7 is a flowchart showing the operation of the optical disk apparatus;

FIG. 8 is a flowchart showing an adjustment process;

FIGS. 9A and 9B are diagram showing changes in frequency distributions;

FIGS. 10A and 10B are diagram showing changes in frequency distributions;

FIGS. 11A and 11B are histograms of pulse widths; and

FIG. 12 is a diagram showing a track structure of an optical disk.

### DESCRIPTION OF THE PREFERRED EMBODIMENTS

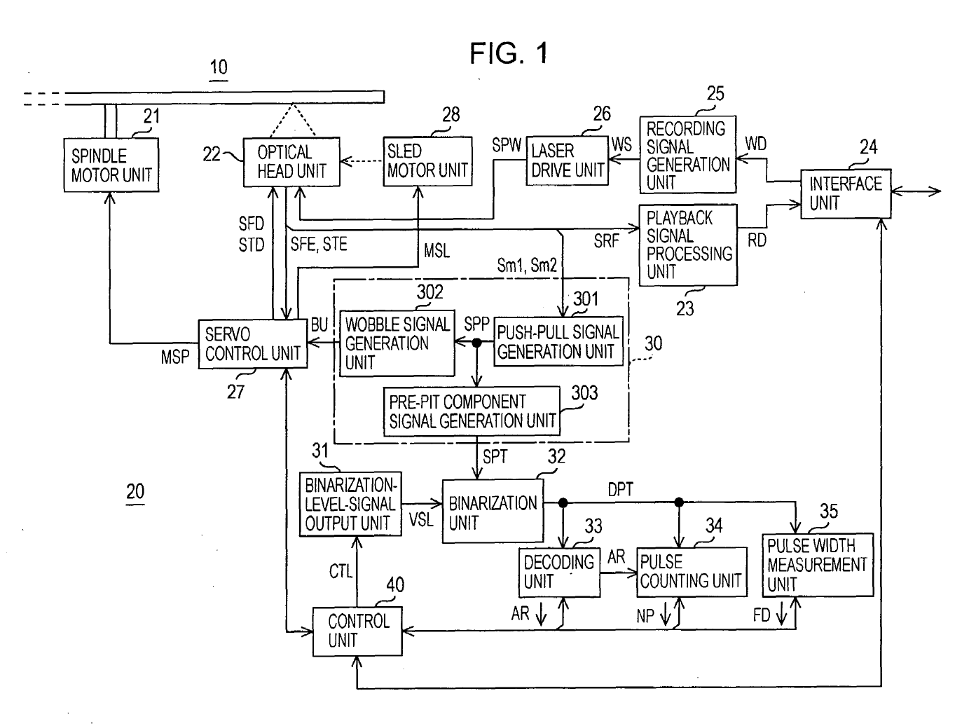

An embodiment of the present invention will be described with reference to the drawings. FIG. 1 is a functional block diagram of an optical disk apparatus 20.

An optical disk 10 using a land pre-pit addressing method is rotated at a predetermined speed by a spindle motor unit 21 of the optical disk apparatus 20. The spindle motor unit 21 is driven by a spindle motor drive signal MSP from a servo control unit 27, as described below, so that the optical disk 10 can be rotated at the predetermined speed.

An optical head unit 22 includes a laser light output element, a light detection element, an optical system for irradiating the optical disk 10 with light output from the laser light output element or guiding light reflected from the optical disk 10 to a light detector, and an actuator for driving a lens for focusing the laser light irradiated on the optical disk 10 onto a desired position. The laser light output element of the optical head unit 22 is driven on the basis of a drive signal SPW from a laser drive unit 26, as described below.

The light detector performs photoelectric conversion to generate a signal corresponding to the irradiated light beam. The light detector also performs processing such as calculation of the generated signal to generate a playback signal SRF, a focus error signal SFE, a tracking error signal STE, and sum signals Sm1 and Sm2. The light detector supplies the generated playback signal SRF to a playback signal processing unit 23, the focus error signal SFE and the tracking error signal STE to the servo control unit 27, and the sum signals Sm1 and Sm2 to a signal generation unit 30.

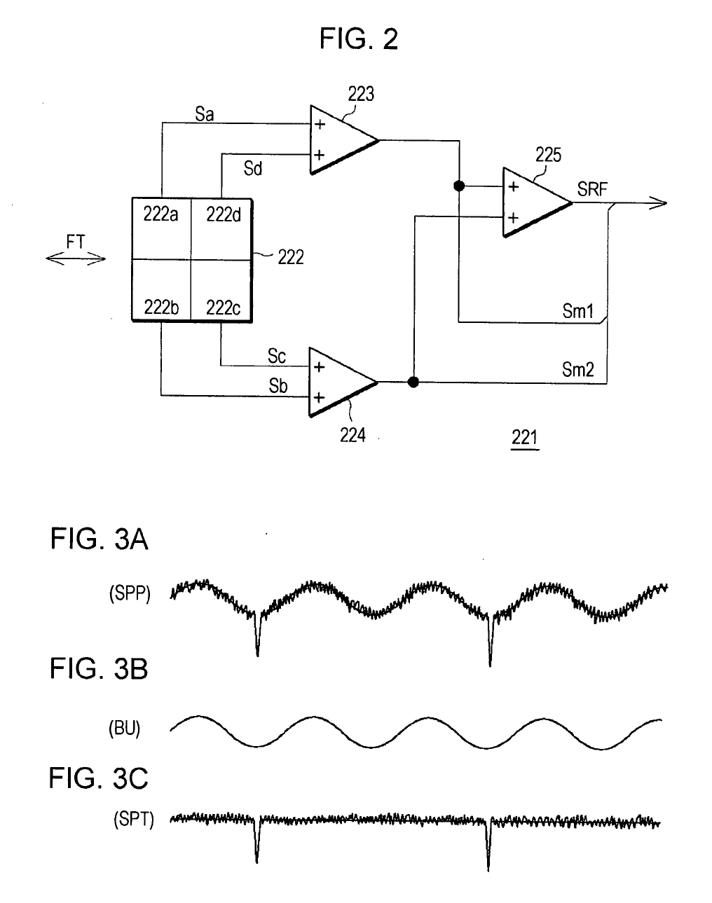

FIG. 2 shows a portion of the structure of the light detector in the optical head unit 22. The light detector 221 includes a photoelectric conversion element 222. The photoelectric conversion element 222 has light-receiving surfaces 222a to 222d divided in a recording-track direction FT of the optical disk 10 (i.e., the circumferential direction of the optical disk 10) and a direction orthogonal to the recording-track direction FT (i.e., the radial direction of the optical disk 10). The photoelectric conversion element 222 receives the light reflected from the optical disk 10 on the four light-receiving surfaces 222a to 222d, and performs photoelectric conversion to generate light-receiving signals Sa to Sd corresponding to the received light.

An adder 223 sums the light-receiving signals Sa and Sd to generate the sum signal Sm1. An adder 224 sums the light-receiving signals Sb and Sc to generate the sum signal Sm2. An adder 225 sums the sum signal Sm1 and the sum signal Sm2 to generate the playback signal SRF. When the adders 223 to 225 are provided with a function for adjusting signal levels, the playback signal SRF and the sum signals Sm1 and Sm2 can be output as signals of desired levels.

Referring back to FIG. 1, the playback signal processing unit 23 binarizes the playback signal SRF, and then sequentially performs demodulation, error correction, and various types of information decoding processing to reproduce information data (such as video data, audio data, and computer data) RD recorded on the optical disk 10. The playback signal processing unit 23 outputs the information data RD via an interface unit 24.

When information data WD to be recorded is supplied via the interface unit 24, the information data WD is supplied to a recording signal generation unit 25. The recording signal generation unit 25 performs processing, such as modulating the information data WD and generating error correction codes, to generate a recording signal WS, and supplies the recording signal WS to the laser drive unit 26.

When a signal recorded on the optical disk 10 is read, the laser drive unit 26 generates a drive signal SPW so that the laser light can be output from the laser light output element of the optical head unit 22 at an output level appropriate to the playback operation, and supplies the drive signal SPW to the optical head unit 22. When a signal is recorded on the optical disk 10, the laser drive unit 26 generates a drive signal SPW so that the laser light modulated on the basis of the recording signal WS can be output from the laser light output element, and supplies the drive signal SPW to the optical head unit 22.

The servo control unit 27 generates a focus drive signal SFD on the basis of the focus error signal SFE from the optical head unit 22. The generated focus drive signal SFD is supplied to the optical head unit 22 to drive the actuator to focus the light beam onto a recording surface of the optical disk 10. The servo control unit 27 also generates a tracking drive signal STD on the basis of the tracking error signal STE from the optical head unit 22. The generated tracking drive signal STD is supplied to the optical head unit 22 to drive the actuator to control the irradiation position of the light beam to a desired position on the optical disk 10. The servo control unit 27 further supplies a sled drive signal MSL to the sled motor unit 28 to move the optical head unit 22 in the radial direction of the optical disk 10 so as not to shift the irradiation position of the light beam out of a tracking control range. The servo control unit 27 also generates a spindle motor drive signal MSP on the basis of a signal such as a wobble signal BU supplied from a wobble signal generation unit 302 of the signal generation unit 30, as described below, so that the optical disk 10 can be rotated at the desired speed, and supplies the spindle motor drive signal MSP to the spindle motor unit 21.

A push-pull signal generation unit 301 of the signal generation unit 30 subtracts the sum signal Sm2 from the sum signal Sm1 to generate a push-pull signal SPP shown in FIG. 3A. The push-pull signal generation unit 301 supplies the generated push-pull signal SPP to the wobble signal generation unit 302 and a pre-pit component signal generation unit 303. The wobble signal generation unit 302 limits the bandwidth of the push-pull signal SPP to extract a wobble frequency component, and generates a wobble signal BU shown in FIG. 3B. The wobble signal generation unit 302 supplies the generated wobble signal BU to the servo control unit 27. The pre-pit component signal generation unit 303 limits the bandwidth of the push-pull signal SPP to extract a frequency component corresponding to land pre-pits, and generates a pre-pit component signal SPT shown in FIG. 3C. The pre-pit component signal generation unit 303 supplies the generated pre-pit component signal SPT to a binarization unit 32.

A binarization-level-signal output unit 31 generates a binarization-level signal VSL of a signal level based on a binarization-level control signal CTL from a control unit 40, as described below, and supplies the binarization-level signal VSL to the binarization unit 32.

The binarization unit 32 binarizes the pre-pit component signal SPT. In the binarization process, the binarization-level signal VSL supplied from the binarization-level-signal output unit 31 is used as a threshold value, and the pre-pit component signal SPT is compared with the binarization-level signal VSL to obtain a pre-pit detection signal DPT indicating the comparison result. In the pre-pit detection signal DPT, pulses represent land pre-pits and the width of the pulses corresponds to the width of the land pre-pits. The binarization unit 32 supplies the generated pre-pit detection signal DPT to a decoding unit 33, a pulse counting unit 34, and a pulse width measurement unit 35.

The decoding unit 33 decodes the pre-pit detection signal DPT to obtain position information, that is, position information AR indicating the position at which the optical head unit 22 irradiates a light beam, and supplies the obtained position information to the pulse counting unit 34 and the control unit 40. If other information is obtained as a result of decoding the pre-pit detection signal DPT, the obtained information is supplied to the control unit 40.

The pulse counting unit 34 counts the pulses of the pre-pit detection signal DPT in units of a period that is based on the position information AR from the decoding unit 33. For example, pulse counting is performed in units of physical sectors on the basis of the position information AR, and count values NP per physical sector are supplied to the control unit 40. The wobble signal BU supplied from the wobble signal generation unit 302 to the servo control unit 27 may be supplied to the control unit 40, and the control unit 40 may determine whether or not wobble for 208 periods has been detected to determine the lapse of one physical sector period. The pulse counting unit 34 may count the pulses in units of physical sector periods according to an instruction from the control unit 40.

The pulse width measurement unit 35 measures a pulse width each time a pulse of the pre-pit detection signal DPT is detected, and creates a distribution of the pulse widths. For example, a frequency distribution in which classes represent the pulse widths and frequency of occurrence represents the number of pulses is generated, and frequency distribution information FD is supplied to the control unit 40 when the pulse width measurement has been performed a predetermined number of times.

The control unit 40 processes a command supplied from an external apparatus via the interface unit 24 to generate a control signal corresponding to the command, and supplies the control signal to the respective units of the optical disk apparatus 20 to control the operation of the optical disk apparatus 20 according to the command. The control unit 40 further determines the irradiation position of the light beam on the basis of the position information AR, and controls the operation of the respective units so that a signal recorded at a desired address can be reproduced or a signal can be recorded at a desired address.

The control unit 40 generates the binarization-level control signal CTL and supplies it to the binarization-level-signal output unit 31 to control the signal level of the binarization-level signal VSL supplied from the binarization-level-signal output unit 31 to the binarization unit 32. The control unit 40 controls the signal level of the binarization-level signal VSL according to the binarization-level control signal CTL on the basis of the count values NP supplied from the pulse counting unit 34 so that, for example, the average of the count values NP becomes equal to a preset value. The control unit 40 further controls the signal level of the binarization-level signal VSL according to the binarization-level control signal CTL on the basis of the information FD indicating the distribution of pulse widths generated by the pulse width measurement unit 35 so that the distribution of pulse widths converges to the pulse width corresponding to the land pre-pits.

The operation of the optical disk apparatus 20 will now be described. The control unit 40 of the optical disk apparatus 20 adjusts the binarization level so that, for example, the average of the number of pulses per physical sector becomes equal to a preset value. The preset value is not limited to one value, and may include values within a certain range.

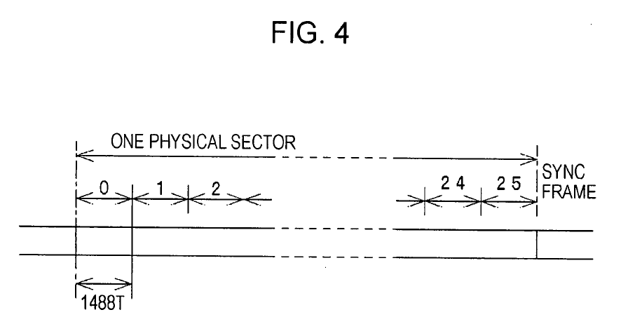

The formation of the land pre-pits will be described. FIG. 4 shows a track structure of an optical disk. One physical sector of a track is formed of 26 sync frames. If a bit interval is denoted by T, one sync frame has a length of consecutive 1488T.

One period of wobble corresponds to 186T. One sync frame period includes eight periods of wobble, and one physical sector period includes 208 periods of wobble. The beginning of each sync frame coincides with a peak of wobble. The land pre-pits are formed at positions with substantially a 90-degree phase difference with respect to zero-cross points of the wobble signal BU shown in FIG. 3B. Therefore, the phase of the signal waveform corresponding to the land pre-pits in the pre-pit component signal SPT shown in FIG. 3C is substantially equal to that of the peaks of the wobble signal BU.

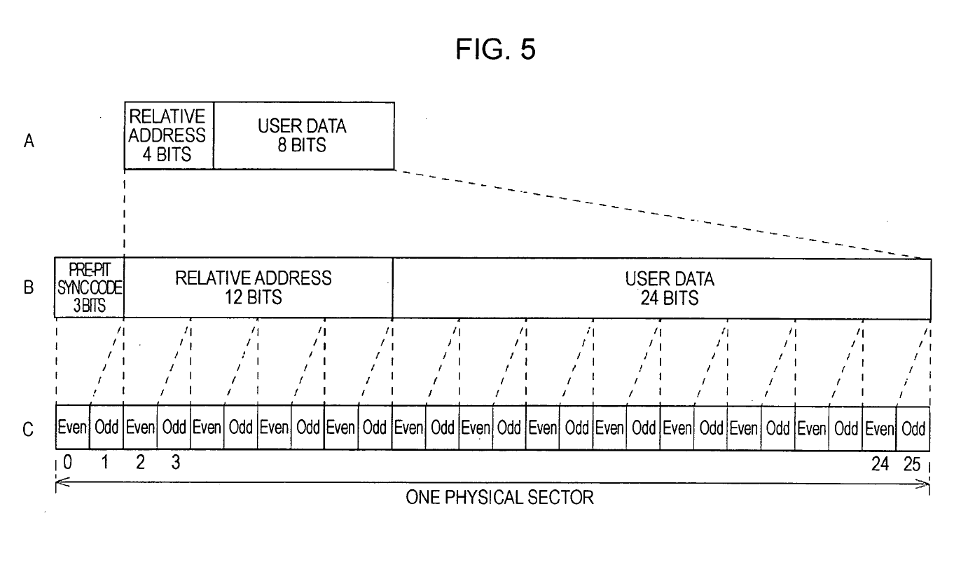

FIG. 5 is a diagram showing the data frame structure of the land pre-pits. As shown in part A of FIG. 5, land pre-pit data is configured such that one frame is formed of a relative address of four bits and user data of eight bits. The relative address is four bits long, and can assign different addresses to 16 data frames. One ECC block is formed of 16 data frames, and the relative address includes addresses per ECC block. The user data indicates an ECC block address, an application code associated with the ECC block address, a code indicating information regarding the physical properties of the optical disk, a manufacturer ID, a parity, and so forth.

The land pre-pit data is converted into frame data having a pre-pit physical sector structure in which, as shown in part B of FIG. 5, a sync code is added after each bit is converted into three bits. Pre-pits corresponding to the frame data are formed in the optical disk 10 as land pre-pits indicating one physical sector formed of 26 sync frames. When the land pre-pits are formed in an optical disk, if those land pre-pits overlap each other in the radial direction of the disk, the positions of the land pre-pits are offset by one sync frame to prevent the overlapping of the land pre-pits. Of the 26 sync frames, as shown in part C of FIG. 5, the first sync frame is set at an even position, the second sync frame is set at an odd position, and the subsequent sync frames are alternately set at even positions and odd positions. That is, the pre-pit sync code, the relative address, and the user data shown in FIG. 5B are used in units of three bits to configure pre-pits, thus providing 13 sync frames at even positions. If the land pre-pits overlap each other, the land pre-pits are offset by one sync frame when the pre-pits are configured using the pre-pit sync code, the relative address, and the user data in units of three bits, thereby providing 13 sync frames at odd positions.

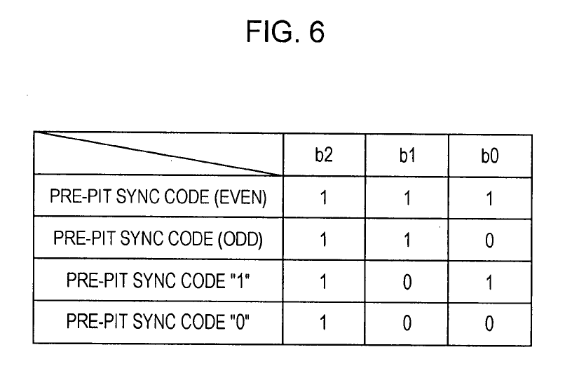

FIG. 6 shows bit allocation for generation of frame data with a pre-pit physical sector structure. The sync code is allocated bit “111”. When land pre-pits overlap each other in the radial direction of the disk, the sync code is allocated bit “110”.

When each bit of the relative address and the user data is “1”, bit “101” is allocated. When each bit is “0”, bit “100” is allocated.

With the above-described bit allocation, the number of land pre-pits per physical sector ranges from 27 at the maximum to 14 at the minimum. That is, when all the bits of the relative address and the user data are “1” and the sync code is set to “111”, the number of pre-pits per physical sector is 27. When all the bits of the relative address and the user data are “0” and the sync code is set to “110”, the number of land pre-pits per physical sector is the minimum, i.e., 14. As is known, the average of the number of land pre-pits per physical sector is a substantially constant value, e.g., 20.

Accordingly, the average of the number of land pre-pits per physical sector is a substantially constant value. The control unit 40 adjusts the binarization level on the basis of the counting result of the pulse counting unit 34 so that an average of count values per physical sector, for example, averages of count values for 16 physical sectors or more, becomes equal to a preset value such as a value within a range from 19 to 21. If the average of count values per physical sector is smaller than 19, the control unit 40 controls the signal level of the binarization-level signal VSL using the binarization-level control signal CTL so as to increase the count values per physical sector. If the average of count values per physical sector is greater than 21, the control unit 40 controls the signal level of the binarization-level signal VSL using the binarization-level control signal CTL so as to decrease the count values per physical sector. By controlling the binarization-level signal VSL on the basis of the count values of the pulse counting unit 34 so that the average of count values per physical sector becomes equal to a predetermined value, therefore, the binarization level can be set to the optimum level.

The control unit 40 may determine an average of count values by calculating a moving average of count values, and may control the binarization level according to the average value. In this case, the control unit 40 can control the signal level of the binarization-level signal VSL in units of physical sectors. The control unit 40 may further control the binarization level using a sum of count values. For example, by controlling the binarization level so that a sum of n count values ranges from 19×n to 21×n, the control unit 40 can control the binarization level without performing the division operation. It is to be understood that count values may be counted in units of a plurality of sectors.

When the signal portion corresponding to the land pre-pits in the pre-pit component signal SPT has a rectangular waveform, the pulse widths measured by the pulse width measurement unit 35 are constantly equal even if the binarization-level signal VSL has different levels. However, since the pre-pit component signal SPT is a signal generated on the basis of the reflected light from the optical disk 10, the signal waveform indicating the land pre-pits rises or falls with a gradient in accordance with the rotation speed of the optical disk 10, the shape of the land pre-pits, etc. Therefore, if the binarization-level signal VSL is close to the peaks of the signal waveform representing the land pre-pits when the pre-pit component signal SPT is binarized, the pre-pit detection signal DPT exhibits a narrow pulse width.

The pulse width measurement unit 35 measures the width of the pulses of the pre-pit detection signal DPT to create a distribution of pulse widths, and the control unit 40 generates the binarization-level control signal CTL so that the distribution of pulse widths converges to the pulse width corresponding to the land pre-pits. For example, the pulse width measurement unit 35 measures the width of the pulses to create a frequency distribution of pulse widths. The control unit 40 compares the frequencies of occurrence for the individual classes in the frequency distribution, and generates the binarization-level control signal CTL on the basis of the comparison results so as to increase the frequency of occurrence for the class of the pulse width corresponding to the width of the pre-pits. Accordingly, the signal level of the binarization-level signal VSL can be optimally adjusted with higher accuracy.

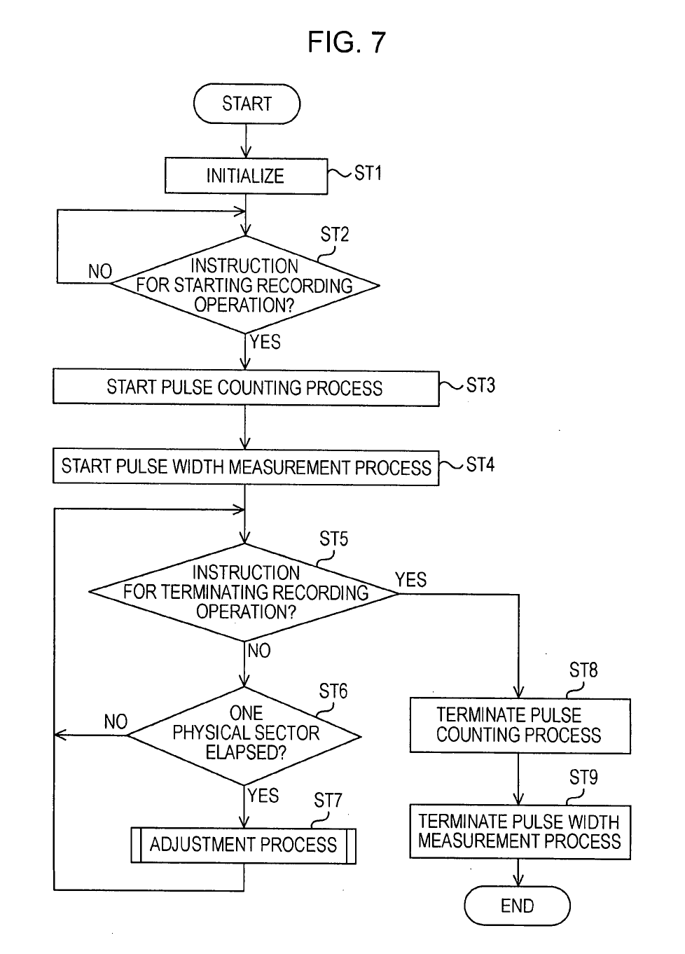

The operation of the optical disk apparatus 20 will now be described with reference to a flowchart shown in FIG. 7. In step ST1, the control unit 40 performs initialization processing. In the initialization processing, the control unit 40 resets a pulse count value, a measured pulse width value, a result of adding up pulse count values, and a distribution of pulse widths to the initial states. Then, the control unit 40 proceeds to step ST2.

In step ST2, the control unit 40 determines whether or not an instruction for starting the recording operation has been issued. When an instruction for starting the recording operation is issued from the outside via the interface unit 24, the control unit 40 proceeds to step ST3. When no instruction for starting the recording operation is issued, the control unit 40 returns to step ST2.

In step ST3, the control unit 40 starts a pulse counting process, and then proceeds to step ST4. That is, the control unit 40 binarizes a pre-pit component signal corresponding to land pre-pits using the binarization-level signal VSL as the initial value or the level designated in the previous playback or recording operation to obtain the pre-pit detection signal DPT, and counts pulses of the pre-pit detection signal DPT.

In step ST4, the control unit 40 starts a pulse width measurement process, and then proceeds to step ST5. That is, the control unit 40 starts to measure the width of the pulses of the pre-pit detection signal DPT obtained in step ST3.

In step ST5, the control unit 40 determines whether or not an instruction for terminating the recording operation has been issued. When no instruction for terminating the recording operation is issued from the outside via the interface unit 24, the control unit 40 proceeds to step ST6. When an instruction for terminating the recording operation is issued, the control unit 40 proceeds to step ST8.

In step ST6, the control unit 40 determines whether or not one physical sector period has elapsed. If one physical sector period has elapsed, the control unit 40 proceeds to step ST7. If one physical sector period has not elapsed, the control unit 40 returns to step ST5. The determination as to whether one physical sector period has elapsed is performed on the basis of, for example, the position information AR from the decoding unit 33. The wobble signal BU supplied from the wobble signal generation unit 302 to the servo control unit 27 may be supplied to the control unit 40, and the control unit 40 may determine whether or not wobble for 208 periods has been detected to determine the lapse of one physical sector period. In this case, the lapse of one physical sector period can be determined regardless of the signal level of the binarization-level signal VSL.

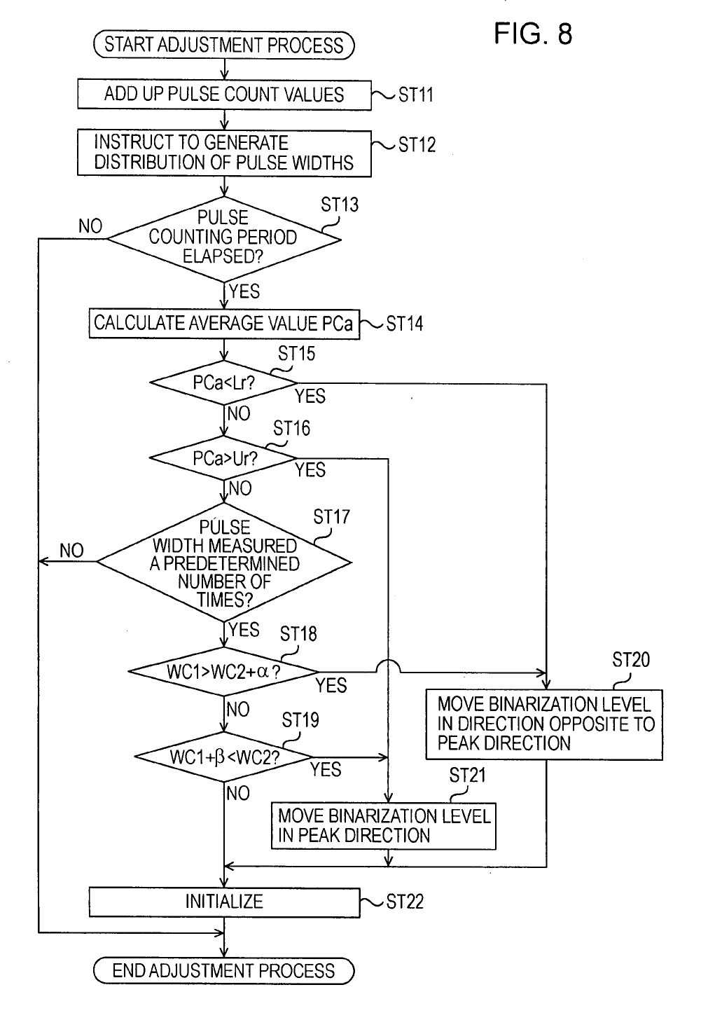

In step ST7, the control unit 40 performs an adjustment process shown in FIG. 8. In step ST11 shown in FIG. 8, the control unit 40 adds up the pulse count values. That is, the control unit 40 counts pulses of the pre-pit detection signal DPT for one physical sector period, and adds up the obtained pulse count values. Then, the control unit 40 proceeds to step ST12.

In step ST12, the control unit 40 gives an instruction to the pulse width measurement unit 35 to generate a distribution of pulse widths, e.g., a frequency distribution of pulse widths, using the measured pulse widths. In the generation of the frequency distribution, classes are defined by the pulse widths, and frequency of occurrence for each of the classes corresponding to the pulse widths measured within one physical sector period is counted up. Then, the control unit 40 proceeds to step ST13.

In step ST13, the control unit 40 determines whether or not a pulse counting period has elapsed. If the pulse counting period has not elapsed, the control unit 40 terminates the adjustment process, and returns to step ST5 shown in FIG. 7. The pulse counting period is set to a period of the number of physical sectors that is determined so that an average of pulse count values per physical sector has a substantially constant value. If the pulse counting period has elapsed, the control unit 40 proceeds to step ST14.

In step ST14, the control unit 40 calculates an average value PCa. Specifically, the control unit 40 divides the sum of the pulse count values for each of the physical sectors in the pulse counting period by the number of physical sectors in the pulse counting period to determine the average value PCa of pulse count values per physical sector. Then, the control unit 40 proceeds to step ST15.

In step ST15, the control unit 40 determines whether or not the average value PCa is smaller than a lower reference value Lr. If the average value PCa is not smaller than the lower reference value Lr, the control unit 40 proceeds to step ST16. If the average value PCa is smaller than the lower reference value Lr, the control unit 40 proceeds to step ST20. The lower reference value Lr is determined by subtracting an allowed range D from an average LPav (=20) of the number of land pre-pits per physical sector. The lower reference value Lr is set to, for example, “LPav−β=20−1”. In this way, it is determined whether or not the average value PCa is smaller than the lower reference value Lr. Therefore, for example, when the level of the binarization-level signal VSL is high so that a signal portion generated by a pre-pit is not detected as a pre-pit to thereby decrease the average value PCa when the component signal SPT is binarized, the level of the binarization-level signal VSL can be adjusted in step ST20, as described below.

In step ST16, the control unit 40 determines whether or not the average value PCa is greater than an upper reference value Ur. If the average value PCa is not greater than the upper reference value Ur, the control unit 40 proceeds to step ST17. If the average value PCa is greater than the upper reference value Ur, the control unit 40 proceeds to step ST21. The upper reference value Ur is determined by adding an allowed range α to an average LPav (=20) of the number of land pre-pits per physical sector. The upper reference value Ur is set to, for example, “LPav+α=20+1”. In this way, it is determined whether or not the average value PCa is greater than the upper reference value Ur. Therefore, for example, when the level of the binarization-level signal VSL is small so that noise superimposed on the push-pull signal SPP is erroneously detected as a pre-pit to thereby increase the average value PCa, the level of the binarization-level signal VSL can be adjusted in step ST21, as described below.

In step ST17, the control unit 40 determines whether or not the pulse width measurement has been performed a predetermined number of times. If the pulse width measurement has not been performed the predetermined number of times, the control unit 40 returns to step ST5 shown in FIG. 7. The predetermined number of times is determined so that the distributed frequencies of occurrence can be clearly distinguished in the frequency distribution generated on the basis of the measured pulse widths and the measurement period is not excessively long. The predetermined number of times is set to, for example, several tens of times to several hundreds of times. If the pulse width measurement has been performed the predetermined number of times, the control unit 40 proceeds to step ST18.

In step ST18, the control unit 40 determines whether or not a frequency of occurrence WC1 of a first class in the frequency distribution is smaller than a value determined by adding a variable α to a frequency of occurrence WC2 of a second class. The first class is a class of a pulse width shorter than the pulse width corresponding to the width of the pre-pits formed in the land tracks, and the second class is a class of a pulse width shorter than the pulse width of the first class. The variables α and β, which is described below, are used to optimally adjust the binarization level.

If the frequency of occurrence WC1 is greater than the value determined by adding the variable α to the frequency of occurrence WC2, the control unit 40 proceeds to step ST20. If the frequency of occurrence WC1 is not greater than the value determined by adding the variable α to the frequency of occurrence WC2, the control unit 40 proceeds to step ST19.

In step ST19, the control unit 40 determines whether or not the value determined by adding the variable β to the frequency of occurrence WC1 of the first class in the frequency distribution is smaller than the frequency of occurrence WC2 of the second class. If the value determined by adding the variable β to the frequency of occurrence WC1 is smaller than the frequency of occurrence WC2, the control unit 40 proceeds to step ST21. If the value determined by adding the variable β to the frequency of occurrence WC1 is not smaller than the frequency of occurrence WC2, the control unit 40 proceeds to step ST22.

In step ST20 from step ST15 or ST18, the control unit 40 moves the binarization level in a direction opposite to the peak direction, and then proceeds to step ST22. Specifically, when the pre-pit component signal SPT shown in FIG. 3C is generated, the control unit 40 generates a binarization-level control signal CTL so that the binarization level moves in a direction away from the peaks of the signal waveform representing the pre-pits (upward direction in FIG. 3C), and supplies the binarization-level control signal CTL to the binarization-level-signal output unit 31. The binarization-level control signal CTL is generated in the manner described above. Therefore, even if the signal waveform based on the land pre-pits has a low peak level, a pre-pit detection signal DPT can be detected. If the pulse width of the pre-pit detection signal DPT is small, which is close to the pulse width corresponding to the width of the pre-pits formed in the land tracks, the frequency of occurrence WC1 of the first class of a pulse width shorter than the pulse width corresponding to the width of the pre-pits is low.

In step ST21 from step ST16 or ST19, the control unit 40 moves the binarization level in the peak direction of the signal waveform representing the land pre-pits, and then proceeds to step ST22. Specifically, when the pre-pit component signal SPT shown in FIG. 3C is generated, the control unit 40 generates a binarization-level control signal CTL so that the binarization level moves toward the peak of the signal waveform representing the pre-pits (downward direction in FIG. 3C), and supplies the binarization-level control signal CTL to the binarization-level-signal output unit 31. The binarization-level control signal CTL is generated in the manner described above. Therefore, for example, even if noise is superimposed on the pre-pit component signal SPT, the number of pulses caused by the noise can be reduced to reduce detection errors of land pre-pits. Erroneous pulse generation, or generation of pulses due to noise or the like, can be reduced, and the frequency of occurrence WC2 of the second class also becomes low.

In step ST22, the control unit 40 performs initialization processing in a manner similar to that in step ST1, and resets the pulse count value, the measured pulse width value, the result of adding up the pulse count values, and the distribution of pulse widths to the initial states. Then, the control unit 40 returns to step ST5 shown in FIG. 7.

When the control unit 40 determines in step ST5 shown in FIG. 7 that an instruction for terminating the recording operation has been issued and proceeds to step ST8, the control unit 40 terminates the pulse counting process, and then proceeds to step ST9. In step ST9, the control unit 40 terminates the pulse width measurement process.

Accordingly, pulses of a pre-pit detection signal are counted, and the signal level of a binarization-level signal is controlled on the basis of the obtained count values. The influence of noise or the like is smaller than that in the case where, for example, the signal level of a push-pull signal is measured and the binarization level is controlled on the basis of the measured signal level. Therefore, the binarization level can be optimally adjusted at any position during recording or playback. Further, since the signal level of the binarization-level signal is controlled so that a distribution of pulse widths converges to the pulse width corresponding to land pre-pits, the binarization level can be adjusted to a more optimal level, and the detection accuracy of land pre-pits can be further enhanced. Furthermore, the predetermined number of times pulse width measurement is performed is determined so that the pulse width measurement is completed within the pulse counting period, thus allowing the binarization level to be controlled for each pulse counting period with high accuracy and the binarization level to be controlled to an optimum state with improved tracking ability. Furthermore, when the average value PCa is within a range defined by the upper reference value Ur and the lower reference value Lr, the determination as to whether the average value PCa becomes equal to a preset value is repeated until the pulse width measurement has been performed the predetermined number of times. Therefore, even if it takes a long time until the pulse width measurement has been performed the predetermined number of times, the binarization level can be controlled on the basis of the measured number of pulses during that period.

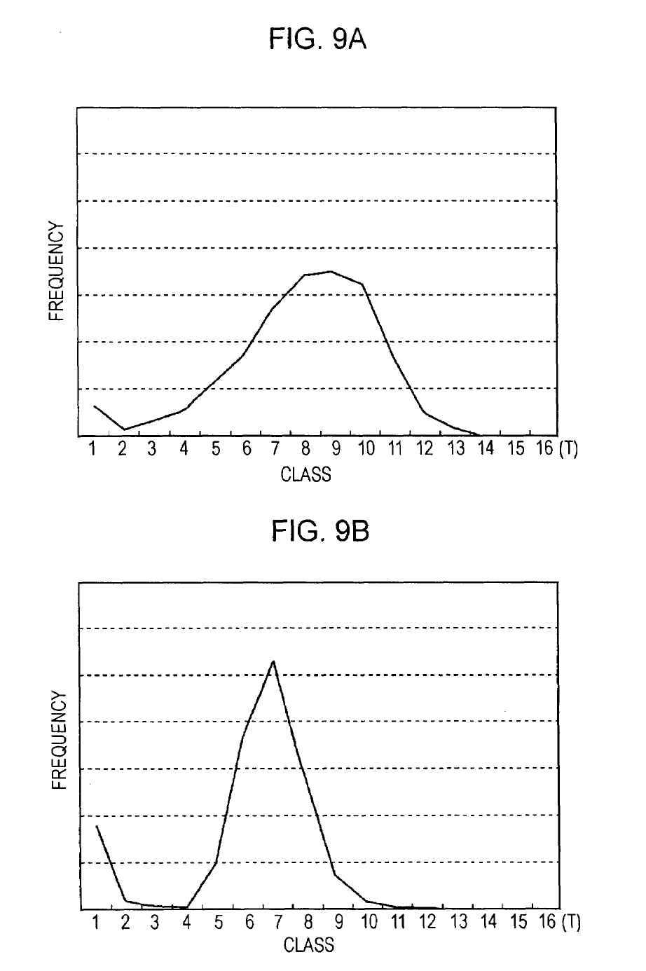

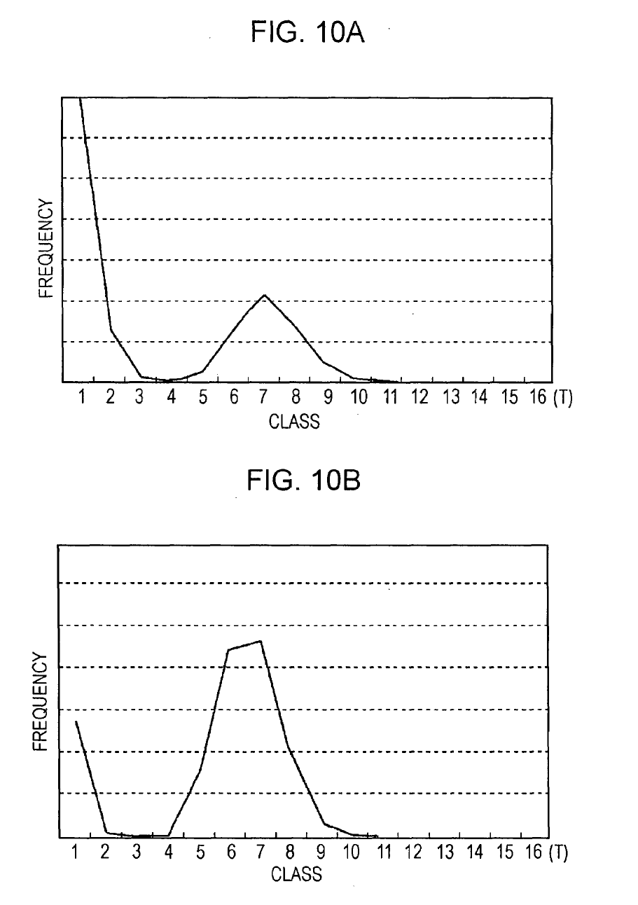

FIGS. 9A to 10B show changes in frequency distributions obtained when the binarization level is controlled so that a distribution of pulse widths converges to a pulse width corresponding to land pre-pits. FIGS. 9A and 9B show an example in which the frequency of occurrence WC1 is greater than the frequency of occurrence WC2 (α=0), and FIGS. 10A and 10B show an example in which the frequency of occurrence WC2 is greater than the frequency of occurrence WC1 (β=0). The frequency distributions shown in FIGS. 9A and 10A are obtained before adjustment for the binarization level, and the frequency distributions shown in FIGS. 9B and 10B are obtained after the adjustment.

When the frequency of occurrence WC1 is greater than the frequency of occurrence WC2, the processing of step ST20 is performed, and the binarization level is moved in a direction opposite to the peak direction of the signal waveform representing the land pre-pits. Therefore, the pulses based on the pre-pits formed in the land tracks approach the pulse widths corresponding to the widths of the pre-pits, and, as shown in FIGS. 9A and 9B, the frequency of occurrence for the pulse widths corresponding to the land pre-pits is larger than that before the adjustment.

When the frequency of occurrence WC2 is greater than the frequency of occurrence WC1, the processing of step ST21 is performed, and the binarization level is moved in the peak direction of the signal waveform representing the land pre-pits. The number of pulses or the like caused by noise can be reduced. Therefore, if the pulse width measurement has been performed the predetermined number of times, as shown in FIGS. 10A and 10B, the frequency of occurrence for the pulse widths corresponding to the land pre-pits is larger than that after the adjustment.

In the flowchart shown in FIG. 8, when the average value PCa becomes equal to a preset value, or a value within a range defined by the upper reference value Ur and the lower reference value Lr, the determination as to whether or not the average value PCa is equal to the preset value is repeated until the pulse width measurement has been performed the predetermined number of times. Alternatively, the control unit 40 may waits to control the binarization level until the pulse width measurement has been performed the predetermined number of times, and may then control the binarization level on the basis of the result of the pulse width measurement performed the predetermined number of times. In this case, the number of times the process for adding up the pulse count values is repeated can be reduced, resulting in simple processing.

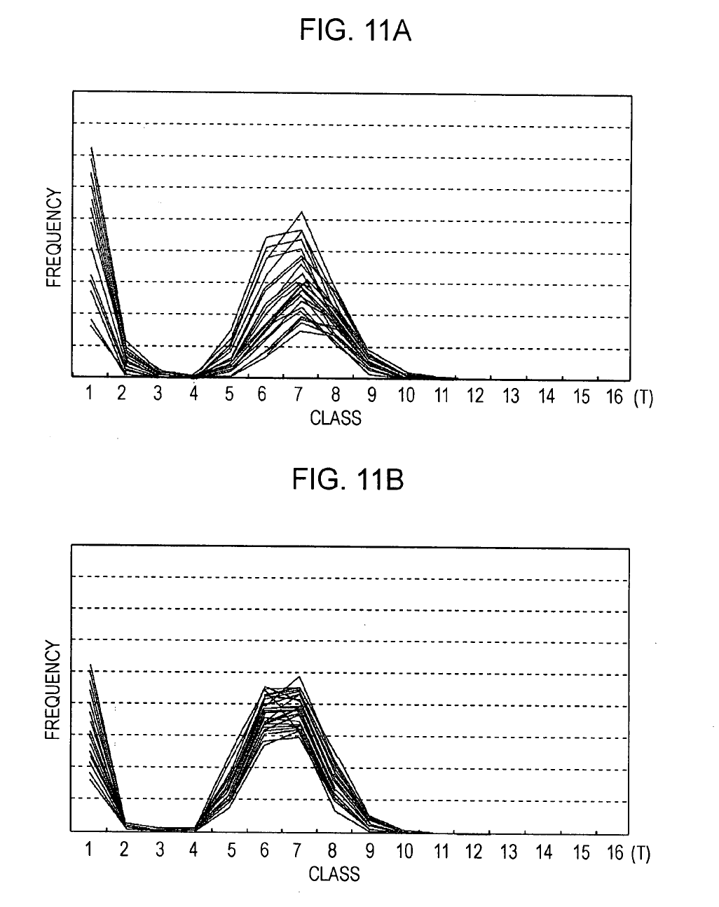

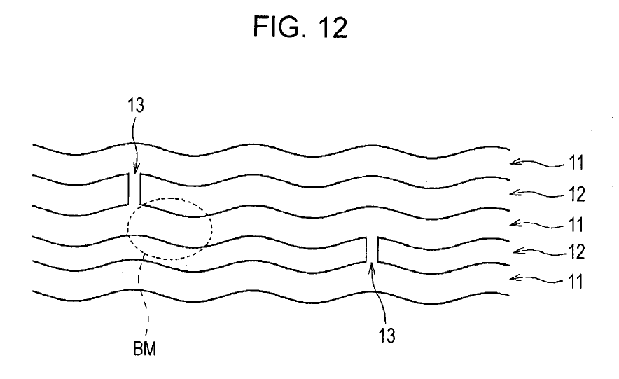

FIGS. 11A and 11B are histograms of pulse widths measured by pulse width measurement units 35 of a plurality of optical disk apparatuses 20. FIG. 11A is a histogram obtained when the average of count values per physical sector is controlled to a preset value. In the histogram shown in FIG. 11A; the frequencies of occurrence for the pulse widths (6T to 7T) corresponding to the length of the pre-pits formed in the land tracks in the disc circumferential-direction are high although waveform variations in the frequency distributions are large.

Here, the binarization level is controlled on the basis of the distribution of pulse widths. In this case, as shown in FIG. 11A, when the frequency of occurrence WC1 for the first class (e.g., 4T) is smaller than the frequency of occurrence WC2 for the second class (e.g., 2T), the binarization level is moved in the peak direction. When the binarization level is controlled in this manner, the binarization level can be more optimally controlled. Therefore, as shown in FIG. 11B, the frequency of occurrence for the second class (2T) can be decreased, and the frequency of occurrence for the pulse widths (6T to 7T) corresponding to the length of the pre-pits can be increased compared with that shown in FIG. 11A. Waveform variations in the frequency distributions generated by the optical disk apparatuses can be reduced.

Accordingly, the binarization level is optimally controlled to thereby increase the detection accuracy of land pre-pits and increase the performance such as address detection. Since the performance such as address detection is high, for example, a signal can be recorded at a correct position. Therefore, the recording quality and the like can also be improved.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disk apparatus using an optical disk having groove tracks and land tracks alternately arranged therein and land pre-pits indicating position information defined in the land tracks, comprising:
an optical head unit having divisional light-receiving surfaces, configured to irradiate the optical disk with a light beam and receive light reflected from the optical disk on the divisional light-receiving surfaces to generate a light detection signal for each of the divisional light-receiving surfaces;
a signal generation unit configured to generate a pre-pit component signal corresponding to the land pre-pits on the basis of the light detection signals;
a binarization-level-signal output unit configured to output a binarization-level signal;
a binarization unit configured to compare the pre-pit component signal with the binarization-level signal to generate a pre-pit detection signal indicating the comparison result;
a decoding unit configured to obtain the position information using the pre-pit detection signal;
a pulse counting unit configured to count pulses of the pre-pit detection signal in units of a period that is based on the position information; and
a control unit configured to control a signal level of the binarization-level signal on the basis of the count values obtained by the pulse counting unit.

2. The optical disk apparatus according to claim 1, wherein the pulse counting unit counts pulses of the pre-pit detection signal in units of physical sectors on the basis of the position information, and
the control unit controls the signal level of the binarization-level signal so that an average of the count values in the units of physical sectors becomes equal to a preset value.

3. The optical disk apparatus according to claim 1, further comprising a pulse width measurement unit configured to measure pulse widths of the pulses of the pre-pit detection signal to create a distribution of the pulse widths,
wherein the control unit controls the signal level of the binarization-level signal on the basis of the distribution of the pulse widths so that the distribution of the pulse widths converges to a pulse width corresponding to the land pre-pits.

4. The optical disk apparatus according to claim 3, wherein the pulse width counting unit creates a frequency distribution of the pulse widths, and
the control unit compares frequencies of occurrence for individual classes in the frequency distribution, and controls the signal level of the binarization-level signal on the basis of the comparison results.

5. A land-pre-pit reproducing method comprising:
irradiating an optical disk with a light beam and receiving light reflected from the optical disk on divisional light-receiving surfaces to generate a light detection signal for each of the divisional light-receiving surfaces, the optical disk having groove tracks and land tracks alternately arranged therein and land pre-pits defined in the land tracks;
generating a pre-pit component signal corresponding to the land pre-pits on the basis of the light detection signals;
outputting a binarization-level signal;
performing binarization by comparing the pre-pit component signal with the binarization-level signal to generate a pre-pit detection signal;
counting pulses of the pre-pit detection signal in units of a predetermined period; and
controlling a signal level of the binarization-level signal on the basis of the obtained pulse count values.
